(19) United States
(12) Patent Application Publication
(10) Pub. No.: US 2007/0022605 A1
(43) Pub. Date: Feb. 1, 2007

(54) NOSE HAIR CUTTER

(75) Inventors: Kazuhiro MORISUGI, Osaka (JP); Toshio IKUTA, Osaka (JP); Yoshimichi KOSUGI, Osaka (JP)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 11/457,845

(22) Filed: Jul. 17, 2006

(30) Foreign Application Priority Data
Jul. 26, 2005 (JP) 2005/216214

(51) Int. Cl. B26B 19/14

(52) U.S. Cl. 30/43.4

(57) ABSTRACT

A main body of an inner blade is inserted into an inner blade insertion hole of an inner blade frame such that the main body can extend and retreat, a tip end cutting edge is pushed by a spring such that it comes into contact with an inner peripheral surface of a slit outer blade, the main body of the inner blade projecting outward from the inner blade insertion hole is bent rearward in a rotational direction, and the cutting edge of the inner blade is located rearward of the main body in the inner blade insertion hole in the rotational direction. With this configuration, the cutting edge does not fall forward in the rotational direction, and no gap is generated between the cutting edge and the inner peripheral surface of the slit outer blade.

### CROSS REFERENCE TO RELATED APPLICATIONS

This application is based upon and claims the benefit of priority from prior Japanese Patent Application P2005-216214 filed on Jul. 26, 2005; the entire contents of which are incorporated by reference herein.

### BACKGROUND OF THE INVENTION

The present invention relates to a nose hair cutter for cutting nose hair.

As a conventional nose hair cutter, as disclosed in Japanese Patent No. 3536345 (Patent document 1, hereinafter) there is a known nose hair cutter including a slit outer blade and an inner blade that is rotated, in which nose hair that enters an inner peripheral surface of the slit outer blade is cut by the inner blade.

According to such a nose hair cutter, as shown in FIG. 1, a main body la of an inner blade 1 is inserted into an inner blade insertion hole 2a of an inner blade frame 2 such that the inner blade 1 can expand and retreat, a tip end cutting edge lb is pushed by a spring (not shown) (pushing direction is shown with arrow a) such that the cutting edge 1b comes into contact with an inner peripheral surface 3a of a slit outer blade 3.

Normally (likewise in the patent document 1), cutting edges 1b of many inner blades 1 is easily formed to have acute angles (to have edges) collectively and thus, the main body 1a of the inner blade 1 projecting outward from the inner blade insertion hole 2a is forwardly bent in a rotational direction R. Therefore, the cutting edge 1b of the inner blade 1 is located closer to a front side than the main body 1a in the inner blade insertion hole 2a in the rotational direction R.

### SUMMARY OF THE INVENTION

If the cutting edge 1b of the inner blade 1 is located closer to the front portion than the main body 1a in the inner blade insertion hole 2a in the rotational direction R, however, when the cutting edge 1b comes into contact with the inner peripheral surface 3a of the slit outer blade 3 by the pushing force of the spring, the cutting edge 1b falls forward in the rotational direction by a component force b of the pushing force a, and a back portion 1c comes into contact with the inner peripheral surface 3a of the slit outer blade 3. With this configuration, a gap t is generated between the cutting edge 1b and the inner peripheral surface 3a of the slit outer blade 3. Thus, there is a problem that pieces of nose hair that enter the inner peripheral surface 3a from a slit groove 3b of the slit outer blade 3 cannot be cut reliably, and cutting sharpness is deteriorated.

The present invention has been achieved to solve the above problem, and it is an object of the invention to provide a nose hair cutter that is devised such that no gap is generated between the cutting edge of the inner blade and the inner peripheral surface of the slit outer blade, thereby enhancing the cutting sharpness.

To solve the above problem, the present invention provides a nose hair cutter including a slit outer blade and an inner blade that is rotated and driven, wherein a main body of the inner blade is inserted into an inner blade insertion hole of an inner blade frame such that the main body can extend and retreat, a tip end cutting edge is pushed by a spring such that it comes into contact with an inner peripheral surface of the slit outer blade, the main body of the inner blade projecting outward from the inner blade insertion hole is bent rearward in a rotational direction, the cutting edge of the inner blade is located rearward of the main body in the inner blade insertion hole in the rotational direction.

According to the present invention, since the cutting edge of the inner blade is located rearward of the main body in the inner blade insertion hole in the rotational direction. With this configuration, when the cutting edge rotates while being in contact with the inner peripheral surface of the slit outer blade by the pushing force of the spring, the cutting edge does not fall forward in the rotational direction. Therefore, no gap is generated between the cutting edge and the inner peripheral surface of the slit outer blade and thus, pieces of nose hair entering into the inner peripheral surface from the slit groove of the slit outer blade can be cut reliably, and the cutting sharpness is enhanced.

To enhance the assembling properties, it is preferable that a detent piece is formed on the main body of the inner blade, a retaining recess is formed in the inner blade insertion hole of the inner blade frame, and the detent piece can be retained to the retaining recess when the main body of the inner blade is inserted.

It is preferable that the inner blade frame is formed with a joint insertion hole of an electric motor that rotates and drives the inner blade, the joint insertion hole passes through the inner blade insertion hole so that the inner blade insertion hole is less prone to be clogged with pieces of cut hair.

### BRIEF DESCRIPTION OF THE DRAWINGS

FIG. 1 is a plan sectional view showing a relationship between an inner blade and a slit outer blade according to a conventional example;

FIGS. 2A and 2B show a nose hair cutter according to an embodiment of the present invention, where FIG. 2A is a front view and FIG. 2B is a side sectional view;

FIG. 3 is an exploded perspective view of a blade assembly;

FIGS. 4A and 4B show the blade assembly, where FIG. 4A is a plan view and FIG. 4B is a front view;

FIG. 5 is a perspective view of an outer blade block and an inner blade block;

FIG. 6A is a sectional view of a the blade assembly, and FIG. 6B is a plan sectional view of an inner blade according to a modification;

FIGS. 7A to 7C are sectional views of FIG. 4B, where FIG. 7A is a sectional view taken along the line A-A, FIG. 7B is a sectional view taken along the line B-B, and FIG. 7C is a sectional view taken along the line C-C; and

FIG. 8 is a plan sectional view showing a relationship between the inner blade and the slit outer blade according to an embodiment of the invention.

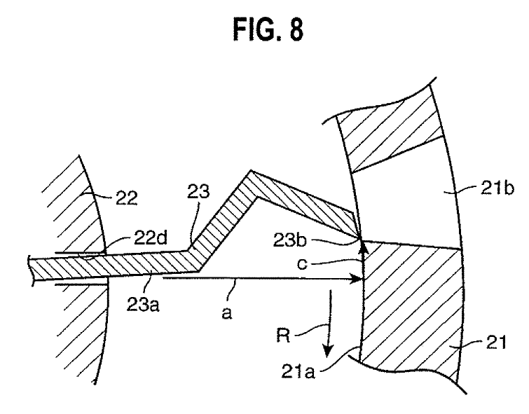

### DETAILED DESCRIPTION OF THE PREFERRED EMBODIMENTS

Embodiments of the present invention will be explained below with reference to the accompanying drawings.

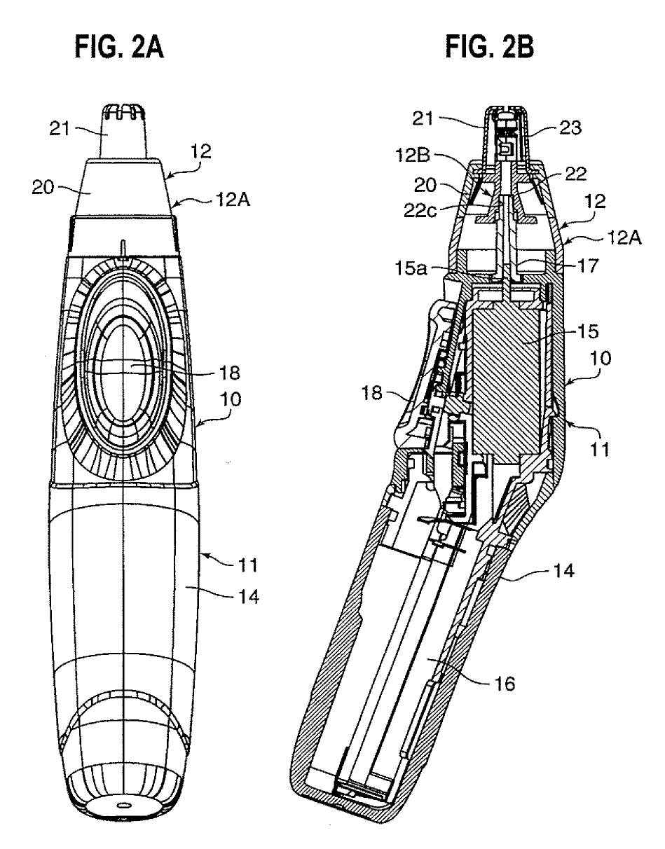

FIG. 2A is a front view of a nose hair cutter 10, and FIG. 2B is a side sectional view of the nose hair cutter 10. The nose hair cutter 10 includes a main body assembly (main body block) 11, and a blade assembly (blade block) 12 detachably amounted on an upper portion of the main body assembly 11.

An electric motor 15 and a dry battery accommodating chamber 16 in which a dry battery for driving the electric motor 15 are provided in a housing 14 of the main body assembly 11. A joint member 17 is press fitted and fixed to an output shaft 15a of the electric motor 15. The front surface of said housing 14 is provided with a push button switch 18 for turning the electric motor 15 ON and OFF.

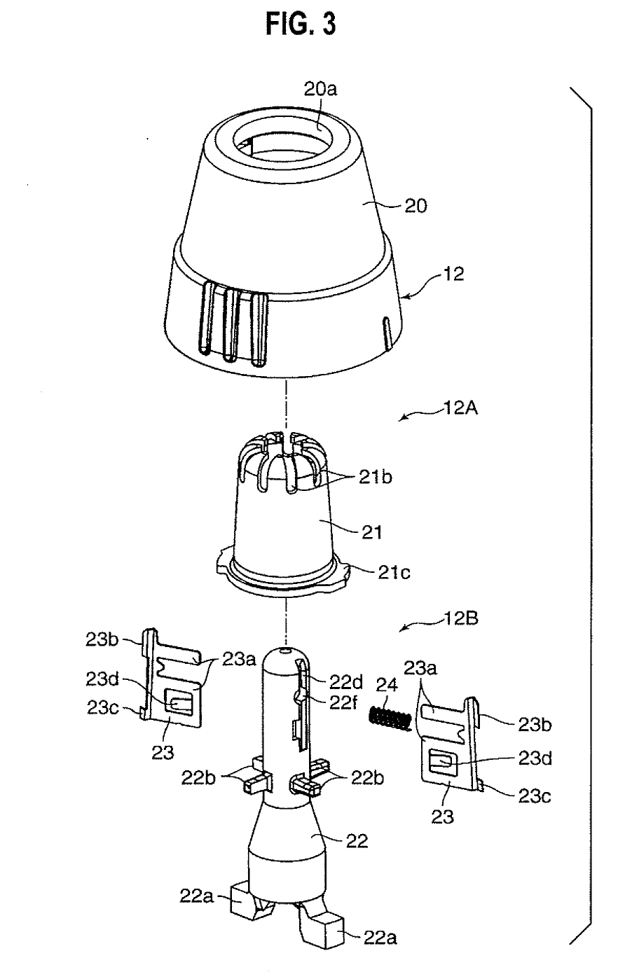

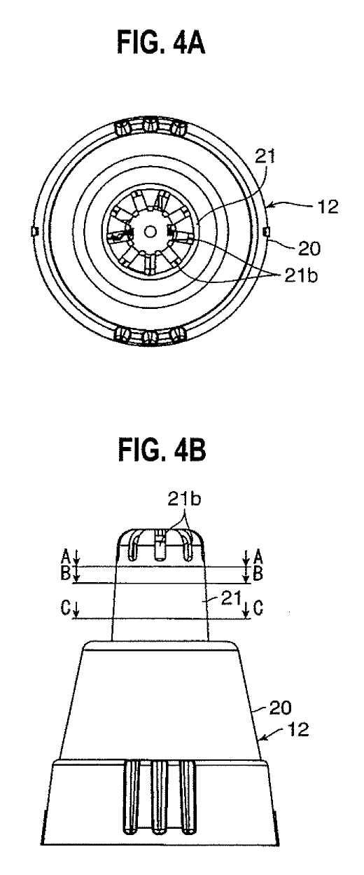

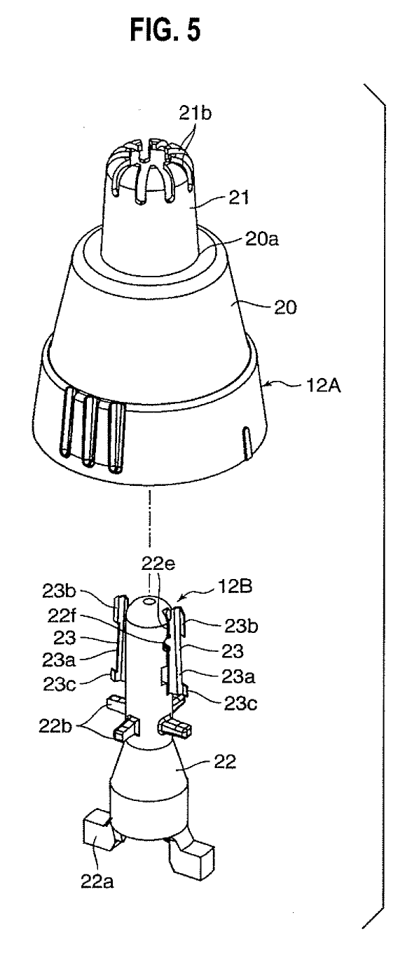

As shown in FIGS. 3 to FIGS. 7A, 7B, and 7C, the blade assembly 12 includes an outer blade block 12A and an inner blade block 12B. The outer blade block 12A includes an outer blade frame 20 and a slit outer blade 21. The inner blade block 12B includes an inner blade frame 22, a pair of inner blades 23 and a coil spring 24.

In the outer blade block 12A, the outer blade frame 20 is formed into a shape of truncated cone pipe, and its top is formed with an opening 20a. A bayonet (not shown) is formed on each of a lower portion of the outer blade frame 20 and an upper portion of the main body assembly 11. The outer blade frame 20 is attached to and detached from the upper portion of the main body assembly 11 by twisting and rotating the outer blade frame 20.

The slit outer blade 21 is formed into a cylindrical shape. The slit outer blade 21 is formed with slit grooves 21b at equal distances (40° in this embodiment) from one another on its circumference such as to extend from an upper portion to a side portion of the slit outer blade 21.

The slit outer blade 21 is inserted into the opening 20a from below the outer blade frame 20, and a base portion 21c is fixed to the outer blade frame 20 in a state where the slit outer blade 21 projects upward from the opening 20a.

In the inner blade block 12B, the inner blade frame 22 is formed into a cannonball-like shape. The inner blade block 12B is formed at its lower portion with knobs 22a used at the time of cleaning operation. The inner blade block 12B is formed at its intermediate portion with positioning projections 22b for determining the insertion position when the inner blade block 12B is inserted into the slit outer blade 21 from below. The inner blade frame 22 is formed at its lower portion with a joint insertion hole 22c through which the joint member 17 of the output shaft 15a of the electric motor 15 is inserted so that the joint member 17 does not rotate. The inner blade frame 22 is rotated by the electric motor 15 through the joint member 17. A later-described inner blade insertion hole 22d of the inner blade frame 22 is inserted through the joint insertion hole 22c.

The inner blade frame 22 is formed at its upper portion with a slit-like inner blade insertion hole 22d extending in a direction perpendicular in its axial direction. A retaining recess 22e and a spring insertion hole 22f are formed in the inner blade insertion hole 22d.

Each of the inner blades 23 is formed into a plate-like shape. A main body 23a is formed at its tip upper end with a cutting edge 23b, and at its tip lower end with an inclination-preventing portion 23c that comes into contact with an inner peripheral surface 21a of the slit outer blade 21 so that the cutting edge 23b does not incline. The main body 23a is integrally formed with a detent piece 23d that is formed by cutting and rising a portion of the main body 23a

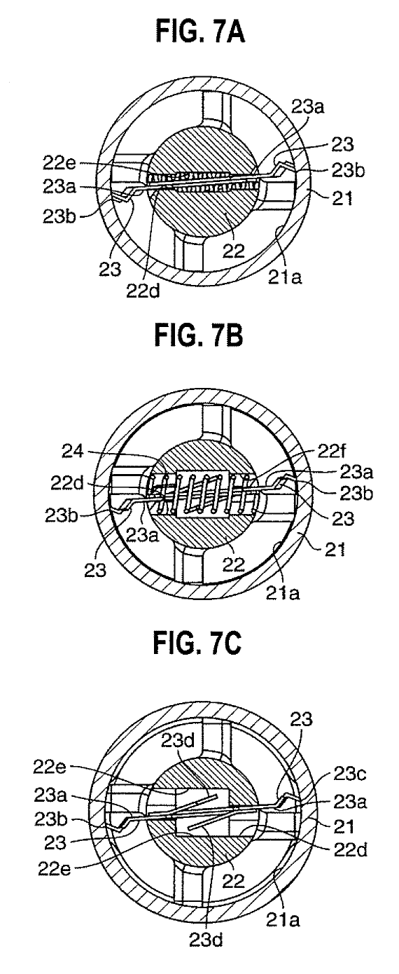

In a state where the spring 24 is inserted into the spring insertion hole 22f of the inner blade frame 22, if the main body 23a of each inner blade 23 is inserted into the inner blade insertion hole 22d from outside against a biasing force of the spring 24 while bending the detent piece 23d, the detent piece 23d restores in the retaining recess 22e in the inner blade insertion hole 22d, and the detent piece 23d can be retained in the retaining recess 22e (see FIG. 7C). With this configuration, in a state where the inner blade 23 is biased outside by the spring 24, the inner blade 23 is retained by the inner blade frame 22 at a constant projection position (position where the cutting edge 23b slightly exceeds a position where the cutting edge 23b comes into contact with the inner peripheral surface 21a of the slit outer blade 21). The main body 23a of each inner blade 23 is inserted into the inner blade insertion hole 22d of the inner blade frame 22 such that the main body 23a can extend and retreat, and the cutting edge 23b at the tip end is pushed and comes into contact with the inner peripheral surface 21a of the slit outer blade 21 by the spring 24.

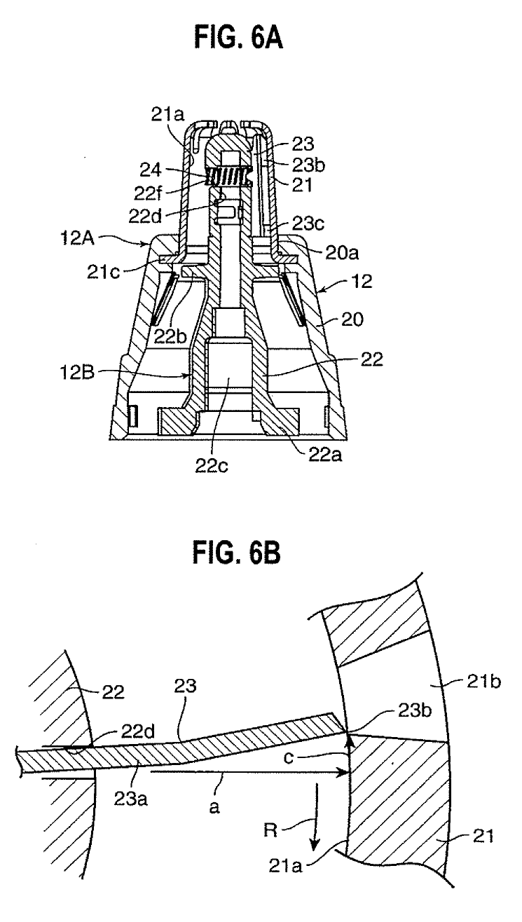

As shown in FIG. 3 in detail, the inner blade 23 is set such that the main body 23a projecting outward from the inner blade insertion hole 22d of the inner blade frame 22 is bent into a L-shape rearward of the rotational direction R as viewed from above, and the cutting edge 23b is located rearward from the main body 23a in the inner blade insertion hole 22d in the rotational direction R. The angle of the cutting edge 23b is an acute angle with respect to the inner peripheral surface 21a of the slit outer blade 21. As shown in FIG. 6B in detail, the inner blade 23 can also be set such that the main body 23a projecting outward from the inner blade insertion hole 22d of the inner blade frame 22 is bent into a “<”-shape rearward of the rotational direction R as viewed from above, and the cutting edge 23b is located rearward from the main body 23a in the inner blade insertion hole 22d in the rotational direction R.

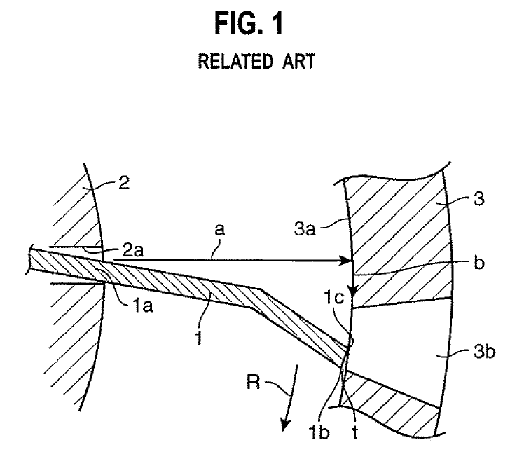

According to the nose hair cutter 10, if the cutting edge 23b of the inner blade 23 is located rearward of the main body 23a in the inner blade insertion hole 22d in the rotational direction R, the cutting edge 23b does not fall forward by a component force (component force in the direction opposite from the component force b of the conventional example shown in FIG. 1) c of the pushing force when the cutting edge 23b rotates while being in contact with the inner peripheral surface 21a of the slit outer blade 21 by the pushing force a of the spring 24. Thus, no gap (see a symbol t in FIG. 1) is generated between the cutting edge 23b and the inner peripheral surface 21a of the slit outer blade 21. Therefore, pieces of nose hair that enter the inner peripheral surface 21a from the slit grooves 21b of the slit outer blade 21 can be cut reliably, and the cutting sharpness is enhanced.

If the main body 23a of the inner blade 23 is inserted into the inner blade insertion hole 22d of the inner blade frame 22, the detent piece 23d of the main body 23a is retained to the retaining recess 22e with a single operation and thus, the assembling performance becomes favorable. Since no other parts is required for preventing the inner blade 23 from being pulled out, the number of parts can be reduced, the cost is reduced, and variation of assembling size can be reduced.

Since the joint insertion hole 22c of the inner blade frame 22 is inserted through the inner blade insertion hole 22d, pieces of cut hair entering into the inner blade insertion hole 22d fall into the joint insertion hole 22c. Therefore, the gap between the inner blade 23 and the inner blade insertion hole 22d is less prone to be clogged with the pieces of cut hair, and extending and retreating motion of the inner blade 23 is not hindered. Thus, it is possible to prevent the cutting sharpness from being deteriorated. If the blade assembly 12 is removed from the main body assembly 11 at the time of cleaning, the joint member 17 on the side of the main body assembly 11 is pulled out from the joint insertion hole 22c on the side of the blade assembly 12. Thus, the pieces of cut hair that fell into the joint insertion hole 22c can be discharged downward from the joint insertion hole 22c.

While the embodiment of the present invention has been described above, the invention is not limited to the above embodiment and changes and modifications can be made within the scope of the gist of the present invention.

What is claimed is:

1. A nose hair cutter comprising a slit outer blade and an inner blade that is rotated, wherein
a main body of the inner blade is inserted into an inner blade insertion hole of an inner blade frame such that the main body can extend and retreat, a tip end cutting edge is pushed by a spring such that it comes into contact with an inner peripheral surface of the slit outer blade, the main body of the inner blade projecting outward from the inner blade insertion hole is bent rearward in a rotational direction, the cutting edge of the inner blade is located rearward of the main body in the inner blade insertion hole in the rotational direction.

2. The nose hair cutter according to claim 1, wherein
a detent piece is formed on the main body of the inner blade, a retaining recess is formed in the inner blade insertion hole of the inner blade frame, and the detent piece can be retained to the retaining recess when the main body of the inner blade is inserted.

3. The nose hair cutter according to claim 1, wherein
the inner blade frame is formed with a joint insertion hole of an electric motor that rotates the inner blade, the joint insertion hole passes through the inner blade insertion hole.

4. The nose hair cutter according to claim 2, wherein
the inner blade frame is formed with a joint insertion hole of an electric motor that rotates the inner blade, the joint insertion hole passes through the inner blade insertion hole.
